(19) United States
(12) Patent Application Publication
(10) Pub. No.: US 2016/0105031 A1
(43) Pub. Date: Apr. 14, 2016

(54) INPUT APPARATUS

(71) Applicant: Samsung Electro-Mechanics Co., Ltd., Suwon-si (KR)

(72) Inventors: Sang Ho CHO, Suwon-si (KR); Chang Ik KIM, Suwon-si (KR); Seung Won PARK, Suwon-si (KR); Yong Woon PARK, Suwon-si (KR); Sang Beom LEE, Suwon-si (KR); Eun Young SHIN, Suwon-si (KR); Jae Suk SUNG, Suwon-si (KR); Jae Hyoung CHO, Suwon-si (KR)

(73) Assignee: Samsung Electro-Mechanics Co., Ltd., Suwon-si (KR)

(21) Appl. No.: 14/636,568

(22) Filed: Mar. 3, 2015

(30) Foreign Application Priority Data
Oct. 10, 2014 (KR) 10-2014-0136738

(51) Int. Cl. H02J 5/00; G05F 5/00; H01F 38/14

(52) U.S. Cl. CPC H02J 5/005; H01F 38/14; G05F 5/00

(57) ABSTRACT

An input apparatus for transmitting received user selection information to a portable terminal held therein may include: a power transmission unit transmitting power to a portable terminal in a non-contact manner. The power transmission unit may include a power transmission coil disposed in a holding unit in which the portable terminal is held and transmitting power to the portable terminal in the non-contact manner.

### CROSS-REFERENCE TO RELATED APPLICATION

This application claims the priority and benefit of Korean Patent Application No. 10-2014-0136738 filed on Oct. 10, 2014, with the Korean Intellectual Property Office, the disclosure of which is incorporated herein by reference.

### BACKGROUND

The present disclosure relates to an input apparatus transmitting user selection information to an electronic device.

Recently, as portable terminals that individuals may readily carry around, such as cellular phones and personal digital assistants (PDAs), have rapidly become prevalent, terminals having various functions and designs have been introduced.

Due to rapid growth in the areas of communications technologies and memory storage, portable terminals have been provided with large capacity memories and high operating speeds.

For example, portable terminals support a wide variety of functions including the transmission and reception of various types of information, such as weather information, stock trading information, and road conditions (traffic) information, the ability to store and play music, and online and offline game functions, in addition to call transmission and reception functions as intrinsic functions thereof.

As mentioned above, a data communications function allowing users to transmit data to and receive data from the devices of others has been added to portable terminals to enhance user convenience.

Also, as high-tech functions such as games, personal computer (PC) synchronization, and global positioning system (GPS) navigation functions are increasingly being provided in portable terminals, the view of portable terminals as composite terminals has been stressed.

In order to meet consumers demand, generally, portable terminals commonly employ touchscreens as user interface devices to provide a relatively large display screen for users.

However, a touch screen is commonly used on the front surface of a main body of a portable terminal, and thus, available keys as input units for inputting data have tended to be reduced, making it somewhat inconvenient for users to use touchscreens to perform certain tasks with portable terminals, such as playing games, or the like.

Also, when a small number of keys are operated in a scrolling manner, performing operations may be somewhat difficult, and as the keys of terminals have tended to be smaller, lighter, and thinner than those of previous devices, the use thereof may be difficult.

As a solution to the foregoing problems, an input apparatus allowing a portable terminal to be held therein and transmitting user selection information to the portable terminal as described in the related art document below has been released.

However, in order to charge a battery thereof with power, a cable for supplying power to the input apparatus and a cable for supplying power to the portable terminal are separately required, thus causing inconvenience in connecting such cables to devices and reducing aesthetic appeal.

[Related Art Document]

(Patent Document 1) U.S. Patent Application Publication No. 2006/0286943

### SUMMARY

An aspect of the present disclosure may provide an input apparatus for transmitting power to a portable terminal in a non-contact manner.

According to an aspect of the present disclosure, an input apparatus for transmitting received user selection information to a portable terminal held therein, may include: a power transmission unit transmitting power to the portable terminal in a non-contact manner.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an outside view schematically illustrating an input apparatus according to an exemplary embodiment of the present disclosure;

FIGS. 2A, 2B, and 2C are outside views schematically illustrating a portable terminal held on the input apparatus according to an exemplary embodiment of the present disclosure;

FIG. 3 includes a plan view and a side view of a power transmission coil employed in the input apparatus according to an exemplary embodiment of the present disclosure; and

FIGS. 4A through 4C are block diagrams of input apparatuses according to various exemplary embodiments in the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

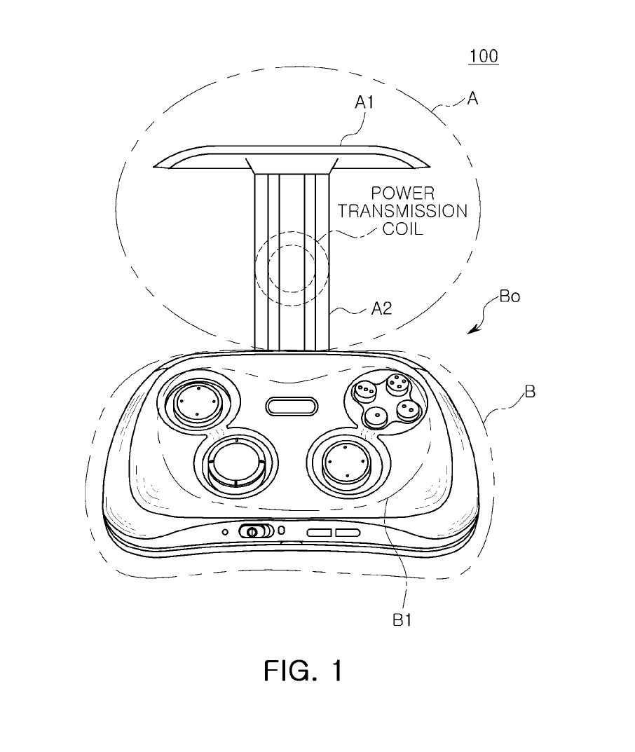

FIG. 1 is a view schematically illustrating an appearance of an input apparatus according to an exemplary embodiment of the present disclosure in the present disclosure.

Referring to FIG. 1, an input apparatus 100 according to an exemplary embodiment of the present disclosure may include a holding unit A and an input unit B.

The holding unit A may include a fixing unit A1 holding and fixing a portable terminal and a support A2 supporting the fixing unit A1 in a portion of a body Bo of the input apparatus 100.

A power transmission coil (indicated by the dotted lines) may be provided within the support A2. The power transmission coil may transmit power to the portable terminal in a non-contact manner. This will be described with reference to the accompanying drawings hereinafter.

The input unit B may include an input button B1.

The input button B1 may include a direction key, a selection key, and the like, and receive a user selection.

Various circuits transmitting user selection information received through the input button B1 of the input unit B to the portable terminal may be included within the body Bo of the input apparatus 100.

The various circuits may include a control circuit receiving a signal from the input button B1 and processing the received signal, a wireless circuit transmitting selection information to the portable terminal, a power circuit for driving these circuits, and the like.

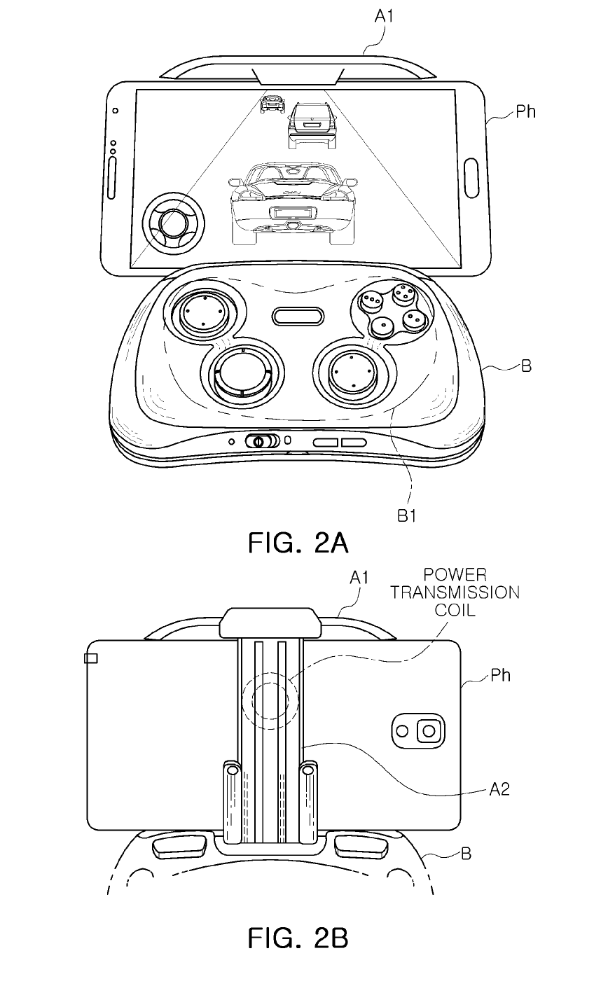

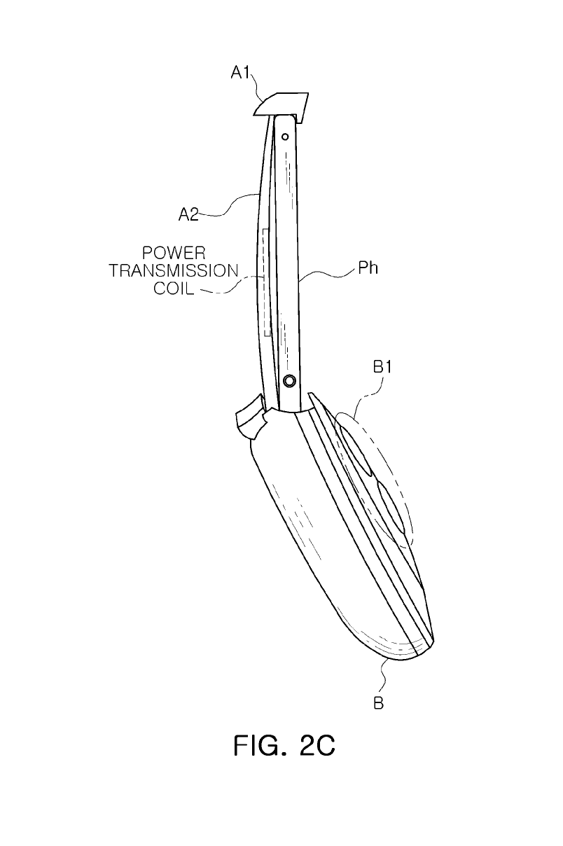

FIGS. 2A, 2B, and 2C are views schematically illustrating an appearance of a portable terminal held on the input apparatus according to an exemplary embodiment of the present disclosure.

FIG. 2A is a front view illustrating a state in which the portable terminal is held on the input apparatus according to an exemplary embodiment of the present disclosure, FIG. 2B is a rear view, and FIG. 2C is a side view.

Referring to FIG. 2A, it can be seen that the portable terminal Ph is held on a holding unit A, and here, the portable terminal Ph may be fixed by the fixing unit A1.

The input button B1 of the input unit B may receive a user selection, and received user selection information may be transmitted to the portable terminal Ph and displayed on a display unit of the portable terminal Ph.

Referring to FIGS. 2B and 2C, a power transmission coil may be provided within the support A2 to transmit power to one surface of the portable terminal Ph in a non-contact manner.

In general, the portable terminal Ph may have a power receiving coil and a power receiving circuit on a rear side of a case in which a battery is installed or within the rear side. As illustrated, the support A2 may be formed between the input unit B and the fixing unit A1 to support the portable terminal Ph.

The input apparatus according to an exemplary embodiment of the present disclosure may have a volume allowing for being carried with the portable terminal, and thus, the volume of the input apparatus may be lighter, thinner, shorter, and smaller.

In addition, in general, as for a power transmission coil, a degree of freedom of charge in horizontal and vertical axes should be seriously considered in order to increase a charge area; however, since a portable terminal is placed on a charge pad, the power transmission coil may be free to some extent in terms of a degree of freedom of charge in a height axis.

In contrast, in the input apparatus according to an exemplary embodiment of the present disclosure, since the portable terminal Ph is held on the holding unit of the input apparatus and has a fixed position, the portable terminal Ph may be free to some extent in terms of a degree of freedom of charge in horizontal and vertical axes but a degree of freedom of charge in the height axis may be considered.

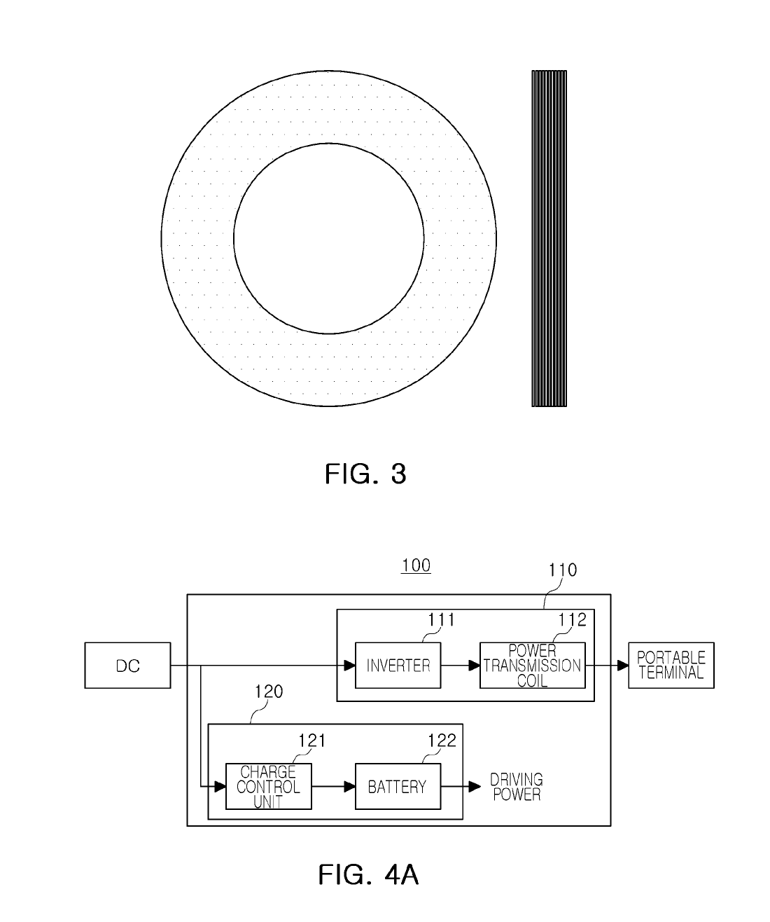

FIG. 3 includes a plan view and a side view of a power transmission coil employed in the input apparatus according to an exemplary embodiment of the present disclosure.

A power transmission coil maybe wound in a spiral shape, and in consideration of a degree of freedom of charge with respect to a height axis, the power transmission coil may be wound in a helical shape.

In addition, a general coil may be wound in a helical shape so as to be used as the power transmission coil, but, in consideration of a reduction in volume, a flat copper wire may be employed as the power transmission coil.

The flat copper wire is thin and has a large surface area, and thus, wire wound resistance does not increase and power transmission efficiency may not be degraded.

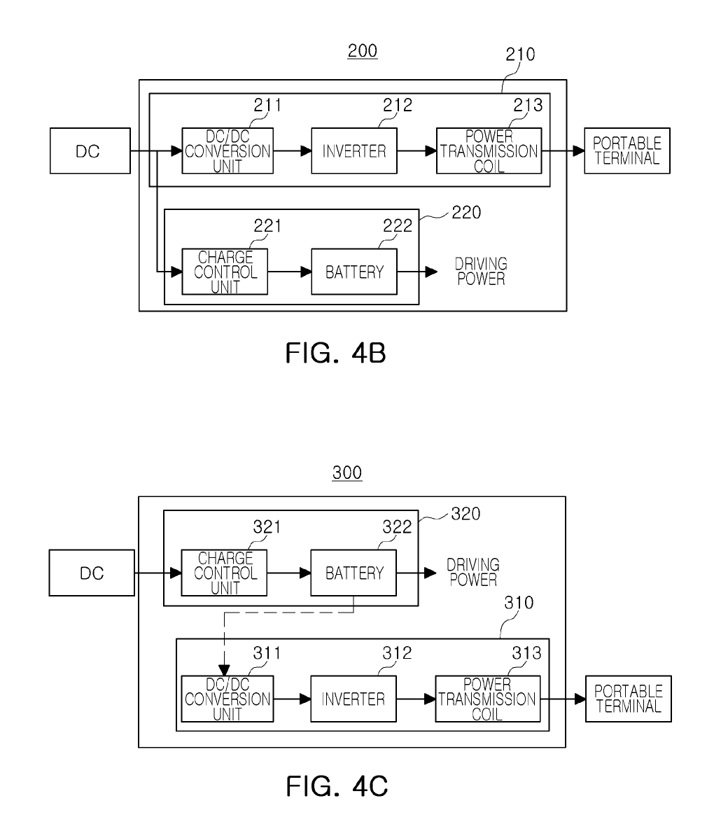

FIGS. 4A through 4C are block diagrams of input apparatuses according to various exemplary embodiments of the present disclosure.

Referring to FIG. 4A, an input apparatus 100 according to an exemplary embodiment of the present disclosure may include a power transmission unit 110 and a power supply unit 120.

The power transmission unit 110 and the power supply unit 120 may receive input power DC separately.

The input power DC may be direct current (DC) power.

The power transmission unit 110 may include an inverter 111 and a power transmission coil 112.

The inverter 111 may switch input power to convert it into transmission power.

The transmission power may be alternating current (AC) power.

The power transmission coil 112 may transmit received transmission power to the portable terminal in a non-contact manner.

Here, the non-contact scheme refers to a scheme in which power is transmitted from a power transmission side to a power reception side without passing through a direct electrical connection between conductors of the power transmission side and the power reception side. In other words, the non-contact scheme may also refer to a contactless scheme, a wireless transmission scheme, and the like.

The power supply unit 120 may include a charge control unit 121 and a battery 122.

The charge control unit 121 may convert input power into charge power appropriate for charging, and transmit the converted power to the battery 122.

The battery 122 may be charged with the charge power from the charge control unit 121 and provide required driving power to internal and external part of the input apparatus 100.

Referring to FIG. 4B, a power transmission unit 210 of an input apparatus 200 according to an exemplary embodiment of the present disclosure may further include a DC/DC conversion unit 211.

The DC/DC conversion unit 211 may convert input power DC into DC power that may be easily processed by an inverter 212, and provide the converted DC power to the inverter 212.

Other functions and operations of the inverter 212 and the power transmission coil 213 are the same as those described above with reference to FIG. 4A, and thus, a detail description thereof will be omitted.

In addition, functions and operations of a charge control unit 221 and a battery 222 of a power supply unit 220 are also the same as those described above with reference to FIG. 4A, except for the foregoing description, and thus, a detail description thereof will be omitted.

Referring to FIG. 4C, a power transmission unit 310 of an input apparatus 300 according to an exemplary embodiment of the present disclosure may further include a DC/DC conversion unit 311.

The DC/DC conversion unit 311 may receive DC power, convert the received DC power into DC power that may be easily processed by an inverter 312, and provide the converted DC power to the inverter 312.

The DC power transmitted to the DC/DC conversion unit 311 may be driving power which has been transmitted from a battery 322 of the power supply unit 320.

When power charged in the battery 322 is sufficient, the driving power may be easily transmitted to the DC/DC conversion unit 311. However, when power charged in the battery 322 is not sufficient, it may be difficult to transmit appropriate driving power to an internal and external part of the input apparatus 300. Thus, when an adapter transmitting input power from the outside is selectively connected, the driving power maybe provided to the DC/DC conversion unit 311.

Other functions and operations of the inverter 312 and the power transmission coil 313 are the same as those described above with reference to FIG. 4A, and thus, a detail description thereof will be omitted.

In addition, functions and operations of a charge control unit 321 and the battery 322 of a power supply unit 320 are also the same as those described above with reference to FIG. 4A, except for the foregoing description, and thus, a detail description thereof will be omitted.

As described above, according to an embodiment of the present disclosure, when the portable terminal is held and used, charging is facilitated and an aesthetically fine appearance may be obtained.

As set forth above, according to exemplary embodiments of the present disclosure, power may be easily charged in a portable terminal held in the input apparatus.

While exemplary embodiments have been shown and described above, it will be apparent to those skilled in the art that modifications and variations could be made without departing from the scope of the present invention as defined by the appended claims.

What is claimed is:

1. An input apparatus for transmitting received user selection information to a portable terminal held therein, the input apparatus comprising:
a holding unit by which the portable terminal is held; and
a power transmission unit transmitting power to the portable terminal in a non-contact manner.

2. The input apparatus of claim 1, wherein the power transmission unit includes a power transmission coil disposed in the holding unit and transmitting received transmission power to the portable terminal in a non-contact manner.

3. The input apparatus of claim 2, wherein the power transmission coil is included within a support of the holding unit facing one surface of the portable terminal and supporting the portable terminal which is held by the holding unit.

4. The input apparatus of claim 3, wherein the power transmission coil has a helical structure.

5. The input apparatus of claim 4, wherein the power transmission coil is a flat copper wire which is wound in the helical structure.

6. An input apparatus comprising a body having a holding unit holding a portable terminal and an input unit transmitting received user selection information to the portable terminal,
wherein the body includes:
a power transmission unit transmitting power to the portable terminal in a non-contact manner; and
a power supply unit supplying driving power to the interior of the body.

7. The input apparatus of claim 6, wherein the power transmission unit includes:
an inverter switching input power to convert the input power into transmission power; and
a power transmission coil disposed in the holding unit, receiving the transmission power, and transmitting the received transmission power to the portable terminal in the non-contact manner.

8. The input apparatus of claim 7, wherein the power transmission coil is included within a support of the holding unit supporting the portable terminal which is held by the holding unit.

9. The input apparatus of claim 7, wherein the power transmission coil is wound in a helical structure.

10. The input apparatus of claim 9, wherein the power transmission coil is a flat copper wire which is wound in the helical structure.

11. The input apparatus of claim 7, wherein the power transmission unit further includes a DC/DC conversion unit DC/DC converting the input power and transmitting the converted power to the inverter.

12. The input apparatus of claim 11, wherein the DC/DC conversion unit DC/DC converts the driving power transmitted from the power supply unit and transmits the converted power to the inverter.

13. The input apparatus of claim 7, wherein the power transmission unit and the power supply unit receive the input power separately.

14. The input apparatus of claim 7, wherein the power transmission unit receives the driving power from the power supply unit.
